(19) United States
(12) Patent Application Publication
(10) Pub. No.: US 2022/0236189 A1
(43) Pub. Date: Jul. 28, 2022

(54) HYPERSPECTRAL NONLINEAR MICROSCOPY

(71) Applicant: Colorado State University Research Foundation, Fort Collins, CO (US)

(72) Inventors: Randy A. Bartels, Fort Collins, CO (US); Jeffrey J. Field, Fort Collins, CO (US)

(21) Appl. No.: 17/648,925

(22) Filed: Jan. 25, 2022

Related U.S. Application Data
(60) Provisional application No. 63/141,195, filed on Jan. 25, 2021.

(51) Int. Cl. G01N 21/65; G01N 21/64

(52) U.S. Cl. CPC G01N 21/65; G01N 21/6486; G01N 21/6458

(57) ABSTRACT

In an example embodiment, a method includes emitting broad bandwidth radiation with high spatial coherence. The method includes applying a time-varying modulation to the broad bandwidth radiation. The method includes identifying optical interactions caused by the time-varying modulation of the broad bandwidth radiation. The method includes identifying one or more signals included in the optical interactions. The method includes extracting one or more respective spectral signatures associated with each respective signal of the one or more signals. The method includes determining a respective characteristic of an optically interacting material that corresponds to a respective spectral signature of the extracted spectral signatures. The method includes identifying one or more optically interacting materials by classifying one or more of the characteristics.

### CROSS-REFERENCE TO RELATED APPLICATION

This application claims the benefit of and priority to U.S. Provisional App. No. 63/141,195 filed Jan. 25, 2021. The 63/141,195 provisional application is incorporated herein by reference.

### FIELD

The present disclosure generally relates to hyperspectral nonlinear microscopy.

### BACKGROUND

Unless otherwise indicated herein, the materials described herein are not prior art to the claims in the present application and are not admitted to be prior art by inclusion in this section.

Biological compounds may be imaged to observe the structure, state, or behavior of the biological compounds. Because the biological compounds are often too small or active within a living organism, the biological compounds may be observed using imaging techniques designed to avoid disturbing the biological activities of the biological compounds. Such imaging techniques include fluorescent labeling techniques or other luminescence-based imaging techniques in which a luminescent or fluorescent material (e.g., a fluorophore) is used to selectively bind to a particular functional group of a biological compound of interest. The material may be a luminescent or fluorescent molecule that emits light in response to absorbing light or other electromagnetic radiation. As such, the material bound to the biological compound may be detected and traced to observe the biological activities of the biological compound.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

In an example embodiment, a method includes emitting broad bandwidth radiation with high spatial coherence, such as by a radiation source. The method includes applying a time-varying modulation to the broad bandwidth radiation. The method includes identifying optical interactions caused by the time-varying modulation of the broad bandwidth radiation. The method includes identifying one or more signals included in the optical interactions. The method includes extracting one or more respective spectral signatures associated with each respective signal of the one or more signals. The method includes determining a respective characteristic of an optically interacting material that corresponds to a respective spectral signature of the extracted spectral signatures. The method includes identifying one or more optically interacting materials by classifying one or more of the characteristics.

In another example embodiment, one or more non-transitory computer-readable storage media store computer-readable instructions that, in response to execution by a processor, cause the processor to perform or control performance of operations. The operations include emitting broad bandwidth radiation with high spatial coherence. The operations include applying a time-varying modulation to the broad bandwidth radiation. The operations include identifying a plurality of optical interactions caused by the time-varying modulation of the broad bandwidth radiation. The operations include identifying one or more signals included in the plurality of optical interactions. The operations include extracting one or more respective spectral signatures associated with each respective signal of the one or more signals. The operations include determining a respective characteristic of an optically interacting material that corresponds to a respective spectral signature of the extracted spectral signatures. The operations include identifying one or more optically interacting materials by classifying one or more of the characteristics.

In another example embodiment, a microscopy system includes a radiation source, a light labeling module, a laser scanning microscope, one or more optical receivers, a processor, and one or more non-transitory computer-readable storage media. The radiation source is configured to emit broad bandwidth radiation with high spatial coherence. The light labeling module is positioned to receive the broad bandwidth radiation from the radiation source and is configured to apply a time-varying modulation to the broad bandwidth radiation. The light labeling module includes a first dispersive optical component, a first lens, a radiation modulator, a second lens, and a second dispersive optical component. The first dispersive optical component is configured to angularly disperse the broad bandwidth radiation incident on the first dispersive optical component. The first lens is configured to focus the dispersed broad bandwidth radiation to a line on the radiation modulator. The radiation modulator includes a modulation mask and the modulation mask includes a first modulation pattern configured to shape the broad bandwidth radiation from the first lens into modulated spectral components. The second lens and the second dispersive optical component are configured to combine the modulated spectral components into modulated radiation. The laser scanning microscope is positioned to receive the modulated radiation and is configured to scan the modulated radiation and/or one or more optically interacting materials with the modulated radiation. The one or more optical receivers are positioned to receive output from the laser scanning microscope. The processor is coupled to the one or more optical receivers and to the one or more non-transitory computer-readable storage media. The one or more non-transitory computer-readable storage media includes computer-readable instructions stored thereon that are executable by the processor to perform or control performance of operations that include identifying in the output of the laser scanning microscope optical interactions caused by the time-varying modulation of the broad bandwidth radiation. The operations include identifying one or more signals included in the optical interactions. The operations include extracting one or more respective spectral signatures associated with each respective signal of the one or more signals. The operations include determining a respective characteristic of an optically interacting material that corresponds to a respective spectral signature of the extracted spectral signatures. The operations include identifying one or more optically interacting materials by classifying one or more of the characteristics.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

Example embodiments will be described and explained with additional specificity and detail through the accompanying drawings in which:

FIG. 1 is a diagram of an example embodiment of a laser scanning microscope that is configured to image optically interactive materials according to at least one embodiment of the present disclosure.

FIG. 2 is a diagram of an example embodiment of a light labeling module according to at least one embodiment of the present disclosure.

FIG. 3 is a diagram of an example of a fundamental pulse spectral output generated according to at least one embodiment of the present disclosure.

FIG. 4 is a flowchart of an example method of imaging optically interactive materials according to at least one embodiment of the present disclosure.

FIG. 5 illustrates a block diagram of an example computing system that may be used to perform or direct performance of one or more operations described according to at least one implementation of the present disclosure.

### DETAILED DESCRIPTION

Biological compounds are often imaged using fluorescent imaging techniques such as fluorescent tagging in which fluorophores that emit light in response to absorbing electromagnetic radiation are attached to the biological compounds. By binding to the biological compounds, the activities or structures of the biological compounds may be observed based on the positioning and activities of the fluorophores. However, fluorescent tagging of biological compounds may damage the biological compounds or disrupt their biological behaviors. Additionally or alternatively, fluorescent tagging or otherwise fluorescent imaging of particular biological compounds may be ineffective if delivery of the fluorophores to corresponding biological compounds is difficult or the fluorophores do not effectively bind to the corresponding biological compounds.

Existing label-free microscopy methods of imaging optically interactive materials, including biological compounds, may provide faster imaging of the optically interactive materials than fluorescent imaging techniques because label-free microscopy techniques typically do not have costs associated with preparatory labeling of material samples. Additionally or alternatively, the existing label-free microscopy techniques, such as diffuse optical, spectral scattering, quantitative phase, linear autofluorescence, nonlinear autofluorescence, Raman, and infrared vibrational imaging, may reduce damage to the materials being imaged. However, existing label-free microscopy techniques may fail to attain the imaging granularity and details captured by fluorescent imaging techniques because such label-free microscopy techniques cannot attain the molecular specificity to image various biomarkers that may facilitate monitoring the state of a cell (e.g., the redox potential of the cell). Furthermore, existing label-free imaging techniques may not effectively serve as diagnostic imaging methods because such imaging techniques may fail to capture interactions between biological molecules that facilitate observation of specific biological functions and pathways. Many of the existing label-free imaging techniques collect spectrally integrated optical signals (e.g., signals relating to emission spectrum amplitudes) while discarding other types of spectral variation information that may or may not convey important information about the optically interactive materials being imaged.

The present disclosure relates to, among other things, a method and/or a system of label-free microscopy of optically interactive materials, such as biological compounds. The label-free microscopy of optically interactive materials according to the present disclosure may include computational optical imaging of nonlinear spectroscopy (i.e., with hyperspectral imaging). Various radiation patterns may be applied to the optically interactive materials, and nonlinear optical interactions between the optically interactive materials and the radiation may include different properties according to the particular radiation pattern that is applied to the optically interactive materials. Based on a known modulation pattern of the radiation and the nonlinear interactions between the radiation and the optically interactive materials, spectral responses associated with each of the optically interactive materials may be computationally generated. For example, a full forward model of a nonlinear spectroscopy signal may be employed to determine a nonlinear spectrum by solving the inverse hyperspectral problem based on the nonlinear spectroscopy signal. As such, the differences and the information provided by each of the nonlinear optical interactions of a particular optically interactive material in relation to different radiation patterns that are applied to the particular optically interactive material may be used to identify the particular optically interactive material based on details included in the spectral responses. Furthermore, imaging a suite of biomarker spatial distributions may facilitate label-free monitoring of biological conditions and serve as a method for disease diagnosis or as a tool for discovery in basic biological sciences for studying model systems, cell cultures, organoids, and engineered tissues.

Reference will now be made to the drawings to describe various aspects of example embodiments of the invention. It is to be understood that the drawings are diagrammatic and schematic representations of such example embodiments, and are not limiting of the present invention, nor are they necessarily drawn to scale.

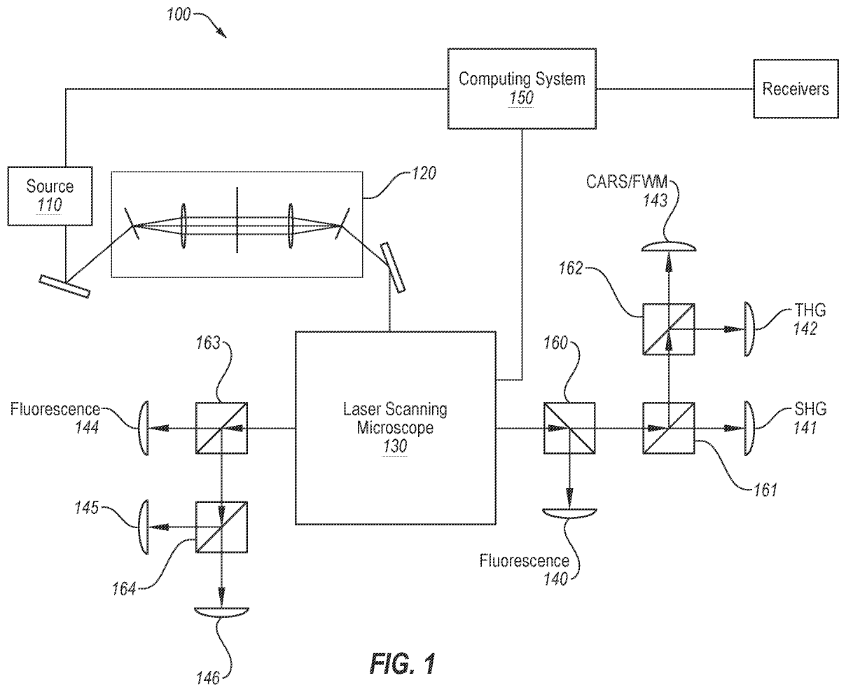

FIG. 1 is a diagram of an example embodiment of a microscopy system 100 that is configured to image optically interactive materials according to at least one embodiment of the present disclosure. The microscopy system 100 may include a radiation source 110 that is configured to emit radiation with high spatial coherence such that phase relationships at different points in a profile of the radiation are strongly correlated with one another. In other words, radiation with high spatial coherence includes electromagnetic waves with highly correlated relationships at different points in space along the electromagnetic waves. In some embodiments, a modal decomposition of radiation with high spatial coherence may contain more than twenty-five coherent modes. In some embodiments, the radiation source 110 may emit broad bandwidth radiation as a continuous radiation beam or as discrete excitation pulses towards a light labeling module 120. In these and other embodiments, the radiation source 110 may include a parabolic fiber amplifier that amplifies a spectrum of the emitted radiation. Additionally or alternatively, the amplified spectrum of the emitted radiation may be broadened using a positive dispersion nonlinear spectral broadening technique to facilitate access to a larger array of biomarkers corresponding to the broadened and amplified spectrum of the radiation.

In some embodiments, radiation emitted by the radiation source 110 may be directed towards the light labeling module 120 by one or more mirrors, lenses, waveguides, or other suitable optical element(s). For example, the radiation emitted in a first direction by the radiation source 110 may be reflected by a mirror such that the radiation is redirected from the first direction towards a second direction. As another example, the emitted radiation may be redirected or otherwise focused by a lens (e.g., a spherical lens, a cylindrical lens, or any other lenses) such that the radiation is directed towards the light labeling module 120.

The light labeling module 120 may include an apparatus that may be placed in a path of the radiation emitted by the radiation source 110 such that the light labeling module 120 may process the radiation before the radiation is obtained by a laser scanning microscope 130. In some embodiments, the light labeling module 120 may be configured to apply a time-varying modulation to the radiation. The light labeling module 120 may include a radiation modulator that modulates the radiation passing through the light labeling module 120. In these and other embodiments, the radiation modulator may include a modulation mask and may be rotated or spun at one or more particular rates of rotation such that the modulation of the radiation varies in a predictable manner as a function of time. Additionally or alternatively, multiple modulation patterns may be angularly multiplexed on a single radiation modulator to adjust complexity of the modulation of the radiation. In some embodiments, the modulated radiation may be outputted by the light labeling module 120 and directed towards and into the laser scanning microscope 130 by one or more mirrors, lenses, waveguides, or other suitable optical element(s).

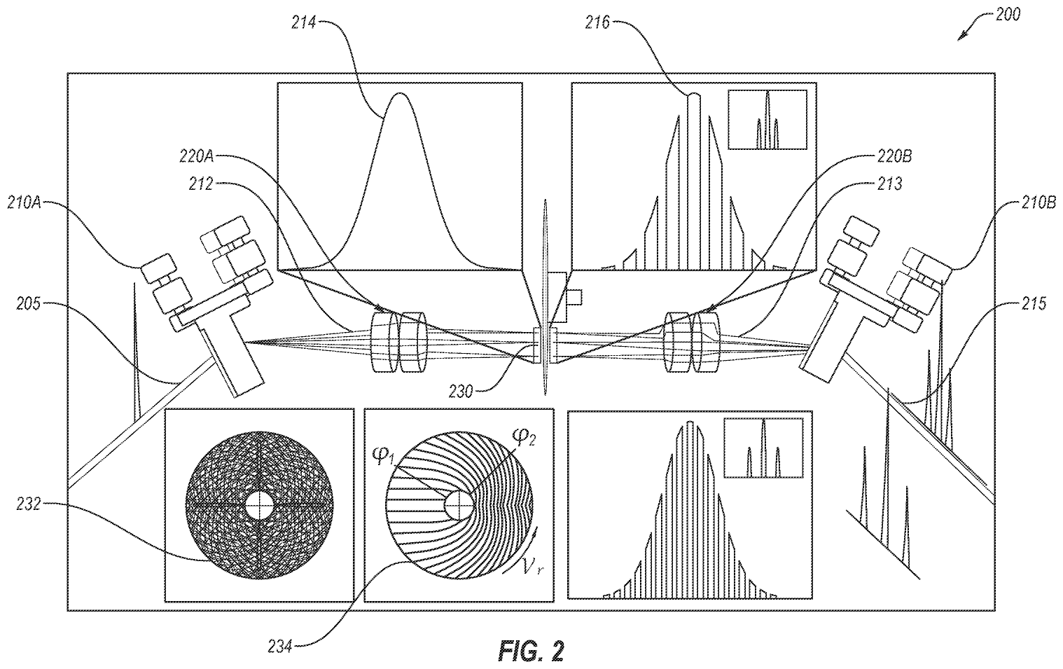

FIG. 2 is a diagram of an example embodiment of a light labeling module 200 according to at least one embodiment of the present disclosure. The light labeling module 200 may include, be included in, or correspond to other light labeling modules herein, such as the light labeling module 120 of FIG. 1. The light labeling module 200 may include a first diffractive optical component 210A (or more generally a first dispersive optical component, such as a grating or prism) that receives and diffracts (or more generally angularly disperses, e.g., via diffraction or refraction) incoming radiation 205 (e.g., from the radiation source 110 of FIG. 1) to generate diffracted radiation 212 (or more generally dispersed radiation) in which different spectral components of the incoming radiation 205 are spatially separated from each other. The diffracted radiation 212 may be focused by one or more first lenses 220A to a line on a radiation modulator 230. The diffracted radiation 212 may form modulated spectral components 213 after passing through the radiation modulator 230. The modulated spectral components 213 may be spatially recombined by one or more second lenses 220B and a second diffractive optical component 210B (or more generally a second dispersive optical component), outputting temporally modulated pulses or modulated radiation 215. The modulated radiation 215 may be directed to and used by a laser scanning microscope, such as the laser scanning microscope 130, and images of samples observed under the laser scanning microscope (e.g., tissue slices, fixed cells, blood smears, isolated mitochondria, or cell lines) may be computationally processed based on the modulated radiation 215.

In some embodiments, the radiation modulator 230 may include a modulation mask, such as a modulation mask 234 in FIG. 2, that includes one or more modulation patterns. The modulation patterns of the modulation mask may selectively obstruct and/or phase shift the diffracted radiation 212 according to a time-varying modulation pattern(s) such that the diffracted radiation 212 forms a time-varying spectral pattern after passing through the radiation modulator 230. In these and other embodiments, the modulation mask may be spun at a particular angular velocity to vary the modulation of the diffracted radiation 212, as indicated at 232 in FIG. 2. The modulation mask 234 is an example of a radiation modulator 230 with multiple modulation patterns angularly multiplexed thereon. The modulation patterns may be arranged at different locations on the modulation mask 234 at different indices offset from a center of the modulation mask 234, such as φ₁ and φ₂, and spun at a rate of vᵣ to vary the modulation of the diffracted radiation 212 as indicated at 232.

The modulation patterns of the modulation mask 234 or other modulation masks may be lithographically printed on glass disks; in some instances, two or more modulation masks may be layered on top of one another to form more complex modulation patterns. The modulation patterns may be arranged at different locations on the modulation mask 234 at different indices, such as φ₁ and φ₂, and the radiation modulator 230 may be powered by a motor running at a rate of vᵣ. The modulation mask 234 is an example of a spatial light modulator (SLM). Additionally or alternatively, any other SLM may be used, including a microelectromechanical systems (MEMS) SLM, a digital light processing (DLP) SLM, a liquid-crystal display (LCD) SLM, a phase-only liquid crystal on silicon (LCOS) SLM, etc.

The diffracted radiation 212 may include a laser spectrum Ê(12), labeled 214 in FIG. 2, at the radiation modulator 230. The modulated spectral components 213 may include a modulated laser spectrum Ê_{LiLa}(Ω, φ), labeled 216 in FIG. 2. In these and other embodiments, the modulated laser spectrum 216 Ê_{LiLa}(Ω, φ) may be generated as a function of the laser spectrum 214 Ê(Ω) and the spinning modulation pattern(s) in the radiation modulator 230 so that computational imaging techniques may be used to unravel multiple nonlinear optical contributions that make up the modulated laser spectrum 216 Ê_{LiLa}(Ω, φ) based on one or more known modulation mask patterns of the radiation modulator 230. As such, intermingled nonlinear signal contributions to the modulated laser spectrum 216 Ê_{LiLa}(Ω, φ) corresponding to different optically interactive materials (e.g., multiple biomarkers present in an imaged sample) may be separated and identified, which in turn facilitates identification of the corresponding optically interactive materials.

For example, radiation pulses modulated by the light labeling module 200 may model forward signal generation according to the following function:

$$m ( Ω , φ ) = \frac{( 1 + cos [ {θ}_{φ} + α {Ω}_{φ} ] )}{2} \qquad ( 1 )$$

in which θ_{φ} is a phase shifting term for spectral extraction and a is a spatial chirp parameter associated with optical frequency Ω. In other embodiments, radiation modulated by the light labeling module 200 may model signal generation according to one or more other functions. For n-photon absorption fluorescent emissions, such as two-photon absorption (2PA) or three-photon absorption (3PA) and n-harmonic generations, such as second harmonic generation (SHG or 2HG) or third harmonic generation (THG or 3HG), a discretized forward signal model may be modeled as a linear matrix equation according to the following function:

$${S}^{( n )} ( φ ) = {\int }_{- ∞}^{∞} {A}^{( n )} ( Ω ; φ ) {\vert {X}^{( n )} ( Ω ) \vert}^{2} , d Ω \qquad ( 2 )$$

in which a hyperspectral operator, A(n)(Ω;φ), maps the nonlinear spectral response, σ⁽ⁿ⁾(Ω):=|X(n)(Ω)|², to a modulation mask dependent signal that varies with a mask variable φ. By applying a discrete frequency variable and a modulation variable (i.e., setting Ωⱼ=jδΩ and φᵢ=iδφ), Equation (2) may be written as a linear model with respect to σ⁽ⁿ⁾Ω by stacking individual measurements on index i:

S⁽ⁿ⁾=A⁽ⁿ⁾σ⁽ⁿ⁾∈ (3)

Here, [ϵ]ᵢ denotes a measurement noise on an i-th discrete cell in φ.

Because a lithographically printed modulation mask according to Equation (1) may be modeled with high precision, a spectral response may be estimated by solving a linear system of equations based on Equation (3). Nonlinearity of the optical interactions, however, causes the measurement operator between the modulation model, m, and the hyperspectral operator, A (n), to be the following equation:

[A⁽ⁿ⁾]ᵢⱼ=FFt{{(IFFT{m(Ωⱼ,φᵢ)})ⁿ} (4)

In some embodiments, a least mean squares estimate may be used to solve the linear system of equations. Additionally or alternatively, other inverse problem optimization or regularization methods may be used, such as a maximum likelihood approach, Bayesian estimation principles, or sparse recovery methods. In these and other embodiments, the least mean squares estimate may be modeled according to the following equation in which A^{(n)#} is a pseudoinverse of A⁽ⁿ⁾:

\tilde{σ}⁽ⁿ⁾=A^{(n)#}S⁽ⁿ⁾ (4)

A spectrum output generated by solving the linear system of equations relating to Equations (2) through (5) may be represented as:

σ⁽ⁿ⁾=Σf (6)

in which the spectrum of each member is a column in an endmember matrix, Σ=( . . . σ^{(2PA)}(Ωⱼ) . . . ), and a relative contribution to the overall spectral response for a kₜₕ chromophore is provided in the vector f. A relative concentration of each chromophore can be solved from this linear system of equations, with the least mean square solution given by:

\tilde{f}=Σ^{#}σ⁽ⁿ⁾ (7)

Additionally or alternatively, estimation methods that account for nonnegativity constraints and return spectral estimates may be utilized.

Coherent scattering samples may be treated in a similar manner as the forward signal generation. In some embodiments, coherent scattering of radiation may be modeled using a coherent superposition as shown in Equation (8) below. A total SHG susceptibility for individual harmonophores, X^{(SHG)}(Ω), may be represented according to Equation (9) below:

σ^{(SHG)}(Ω)=|χ^{(SHG)}(Ω)|² (8)

X^{(SHG)}(Ω)=ΣₖfₖXₖ^{(SHG)}(Ω) (9)

Additionally or alternatively, coherent anti-Stokes Raman scattering (CARS or CARS scattering) may be modeled as a mixture of vibrational spectra and four-wave mixing as shown below:

S^{(CARS)}(φ)=∫|Ê(,φ)_{*Ω}{(X_{FWM}⁽³⁾(Ω)+X_{VR}⁽³⁾(Ω))A^{(CARS)}(Ω,φ)}|dΩ (10)

Modifications, additions, or omissions may be made to the light labeling module 200 without departing from the scope of the present disclosure. For example, the designations of different elements in the manner described is meant to help explain concepts described herein and is not limiting. For instance, in some embodiments, the diffractive optical components 210A, 210B, the lenses 220A, 220B, and the radiation modulator 230 are delineated in the specific manner described to help with explaining concepts described herein but such delineation is not meant to be limiting. Further, the light labeling module 200 may include any number of other elements or may be implemented within other systems or contexts than those described. For example, the diffractive optical components 210A, 210B and/or the lenses 220A, 220B may include any other angular dispersive optical components, such as a prism for refracting incoming radiation. Further, any other processes for modulating the radiation so as to encode variation on a measured signal and facilitate extraction of a corresponding spectral response may be used. For example, a time-domain modulator on a chirped spectrum or a dual-comb laser source may be implemented to modulate the radiation.

Returning to the description of the microscopy system 100 of FIG. 1, the radiation emitted by the radiation source 110 and modulated by the light labeling module 120, e.g., the modulated radiation 215 of FIG. 2, may be received by the laser scanning microscope 130. In some embodiments, the laser scanning microscope 130 may use the modulated radiation to scan one or more samples that include optically interactive materials that may interact in response to being exposed to the modulated radiation.

Because the modulated radiation may include a particular and known time-varying spectral pattern, the optically interactive materials may exhibit corresponding optical interactions according to the particular known time-varying spectral pattern to which the optically interactive materials are exposed. In some embodiments, the optical interactions of the optically interactive materials generated in response to the modulated radiation with the known spectral pattern from the light labeling module 120 may be processed and analyzed, e.g., using one or more optical receivers 140-146 and a computing system 150, such that one or more signals included in the optical interactions may be identified. The computing system 150 may be coupled, e.g., communicatively coupled, to one or more of the source 110, the laser scanning microscope 130, and/or the optical receivers 140-146 and may include a processor to perform or control performance of one or more of the operations described herein.

The optical receivers 140-146 may each include a photomultipler tube (PMT) or other suitable optical receiver. In some embodiments, the microscopy system 100 further includes one or more optical filters 160-164. The filters 160-164 and the optical receivers 140-146 may be used to isolate and collect the optical interactions from the output of the laser scanning microscope 130. In the illustrated example, the microscopy system 100 includes optical receivers 140-143 and filters 160-162 in a forward direction and optical receivers 144-146 and filters 163, 164 in an epi direction. The filter 160 may filter out fluorescence from the forward output of the laser scanning microscope 130 for collection at the optical receiver 140. The filter 161 may filter out SHG from the forward output for collection at the optical receiver 141. The filter 162 may filter out THG from the forward output for collection at the optical receiver 142. CARS/FWM in the forward output may pass through the filter 162 for collection at the optical receiver 143. The filter 163 may filter out fluorescence from the epi output of the laser scanning microscope 130 for collection at the optical receiver 144. The filter 164 may filter out CARS/FWM from the epi output for collection at the optical receiver 145. SHG in the epi output may pass through the filter 164 for collection at the optical receiver 146.

In some embodiments, one or more spectral signatures may be extracted from or based on the optical interactions. Spectral signatures corresponding to the identified signals may be computationally extracted from analysis of the optical interactions. For example, the optical interactions collected at the optical receivers 140-146 may be analyzed by the computing system 150 to identify various signals according to various signal-identification rules or guidelines. One or more characteristics of the optically interactive materials may be determined that correspond to the extracted spectral signatures. Finally, an identity of each of the optically interactive materials may be determined based on the determined characteristics.

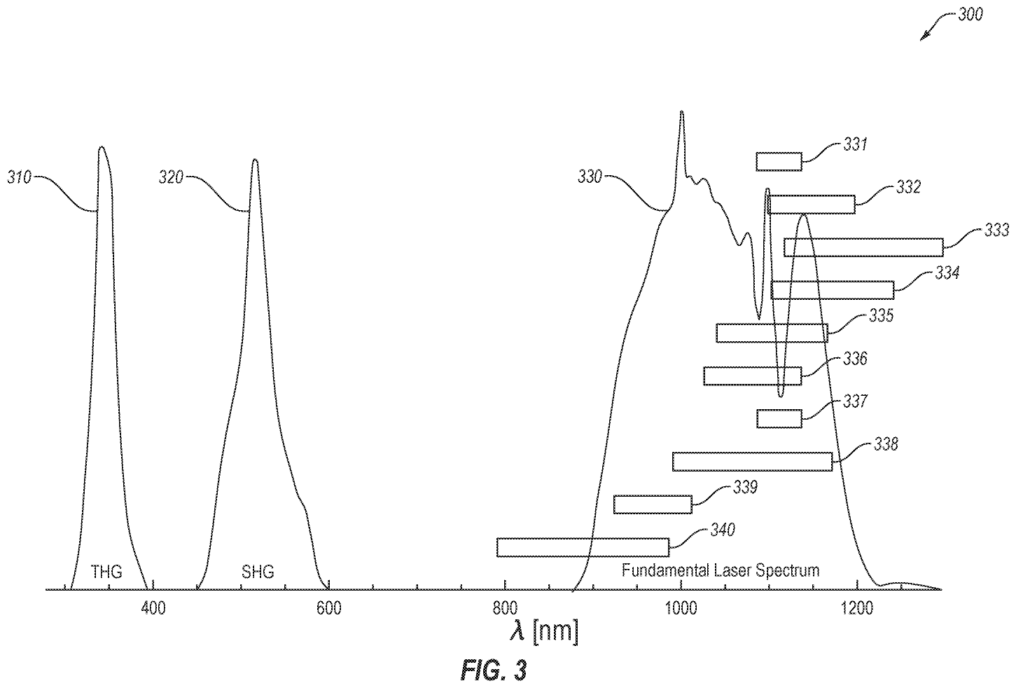

FIG. 3 is a diagram of an example fundamental pulse spectral output 300 generated according to at least one embodiment of the present disclosure. The fundamental pulse spectral output 300 may include spectral signals of varying intensities detected at various wavelengths of electromagnetic radiation, A (nm). Different optical interactions may result in different spectral signals of varying intensities being output. For example, a THG optical process may generate a spectral output represented by a first spectral output 310, and an SHG optical process may generate a spectral output represented by a second spectral output 320.

As another example, a third spectral output 330 corresponding to a fundamental laser spectrum of one or more optically interactive materials may be generated. Each of the optically interactive materials may include a unique spectral output that corresponds to a given radiation pattern absorbed by the optically interactive material. In other words, a particular optically interactive material may output a corresponding spectral output at a particular wavelength and a particular intensity that depends on the given radiation pattern absorbed by the particular optically interactive material. As such, one or more optically interactive materials may be identified based on spectral output patterns included in the third spectral output 330. In this and other examples, a first spectral peak 331 may correspond to 3 PA spectral output behavior of lipofuscin, and a second spectral peak 332 may correspond to the 3PA spectral output behavior of collagen. A third spectral peak 333, a fourth spectral peak 334, a fifth spectral peak 335, a sixth spectral peak 336, and a seventh spectral peak 337 may respectively correspond to the 3PA spectral output behaviors of retinol, elastin, folic acid, nicotinamide adenine dinucleotide (NADH), and hemoglobin. An eighth spectral peak 338 and a ninth spectral peak 339 may respectively correspond to four-photon absorption (4PA) spectral output behavior of tryptophan and serotonin. Additionally or alternatively, a tenth spectral peak 340 may correspond to 2PA spectral output behavior of flavin adenine dinucleotide (FAD). The foregoing are non-limiting examples of optically interactive materials and spectral output patterns, and other optically interactive materials may be identified based on other spectral output patterns according to the present disclosure.

In some embodiments, various fundamental pulse spectral outputs such as the fundamental pulse spectral output 300 may be generated by imaging various different optically interactive materials that have known compositions of biological or other chemical compounds. A library cataloguing the optically interactive materials and their respective spectral profiles may be developed to facilitate analysis of unknown compositions or materials (e.g., biomolecule identification, tissue classification, cell typing, biomarker labeling, etc.).

In these and other embodiments, the optically interactive materials being imaged may include live cells. In some situations, different spectral outputs generated based on different radiation modulation patterns may provide various types of information about the live cells. For example, redox potential of a live cell may be measured based on fluorescence of NADH or FAD molecules. As additional examples, 2PA spectral outputs may be used to identify biomolecules such as melanin, cytochrome-c, and lipofuscin, and THG spectral outputs may be used to identify human melanocyte cells. Additionally or alternatively, known and unknown nonlinear spectral outputs may be compared for various cells to observe changing state conditions of the cells.

Returning to the description of the microscopy system 100, in some embodiments, coherent scattered radiation is collected in a forward direction relative to the direction of radiation emission (i.e., in the direction of the radiation emission) because scattering of coherent radiation is much stronger in the forward direction (i.e., greater radiation intensity), while fluorescent radiation may be collected in a backward direction where coherent scattering is relatively weaker. In these and other embodiments, the filters 160-164 and the optical receivers 140-146 may be employed to record fluorescent emission bands and/or optical interactions (SHG, THG, CARS) in the forward output and/or the epi output of the laser scanning microscope 130. The signals collected at each PMT may be recorded with a multi-channel data acquisition system (DAQ) and processed to extract a multiphoton absorption cross-section and spectrally resolved optical scattering (e.g., SHG, THG, or CARS spectral outputs). Accordingly, the spectral modulation of the radiation emitted by the radiation source 110 and a forward model of the nonlinear optical interactions may be used to computationally extract a hyperspectral response of the nonlinear optical interactions, resulting in the separation of the nonlinear optical interaction orders. In these and other embodiments, residual spectral overlaps in the spectral output (e.g., the fundamental pulse spectral output 300) may be computationally removed.

The spectral outputs generated by the laser scanning microscope 130 may be used for a variety of data analysis purposes. In some embodiments, the spectral outputs may be used for accuracy testing of spectroscopic recovery algorithms, which may improve or refine the tested algorithms. The spectral outputs may be used to benchmark detection limits in complex mixtures of biological and other chemical materials. In these and other embodiments, the spectral outputs may be used to facilitate study of the relationship to a signal-to-noise ratio (SNR) of the observed optically interactive materials corresponding to the spectral outputs. The spectral outputs may be used to investigate more robust nonlinear light labeling approaches and joint estimation (e.g., for CARS spectra).

Additionally or alternatively, the spectral outputs may assist the development of hyperspectral analysis and classification algorithms. Hyperspectral imaging tools, such as multivariate curve resolution, morphological data analysis, and diffusion maps for manifold learning, may be applied to the spectral outputs generated according to the present disclosure in simulations and/or real data to identify salient topological and geometric features included in the spectral outputs that distinguish various biological classes.

Additionally or alternatively, the spectral outputs may be used with reconstruction algorithms that are benchmarked against experimental data to further develop modulation patterns and improve the reliability and fidelity of data. More precise construction of the modulation patterns may improve speed or discrimination between different optically interactive materials of interest included in the sample observed under the laser scanning microscope 130. For example, local spatial frequencies and amplitudes of the modulation patterns may be adjusted such that high frequency modulation of the adjusted modulation patterns may capture frequency domain lifetime information regarding fluorescent emissions.

Modifications, additions, or omissions may be made to the microscopy system 100 without departing from the scope of the present disclosure. For example, the designations of different elements in the manner described is meant to help explain concepts described herein and is not limiting. For instance, in some embodiments, the light labeling module 120, the laser scanning microscope 130, the filters 160-164 and the optical receiver 140-146 are delineated in the specific manner described to help with explaining concepts described herein but such delineation is not meant to be limiting. Further, the microscopy system 100 may include any number of other elements or may be implemented within other systems or contexts than those described.

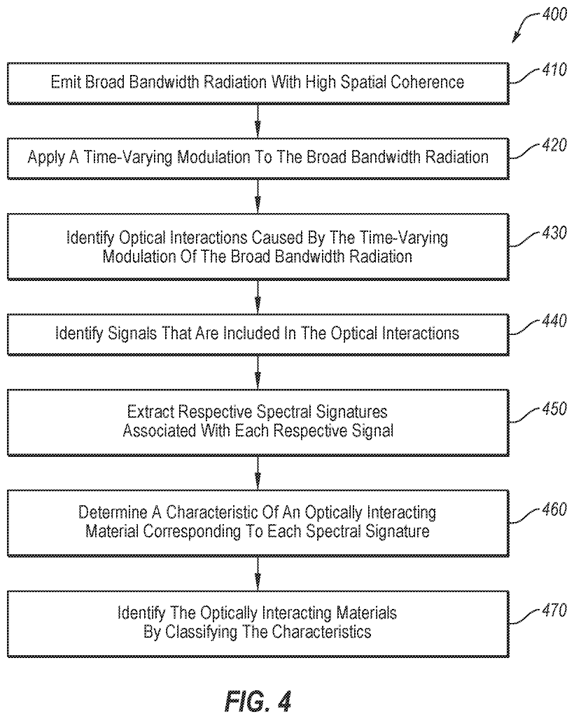

FIG. 4 is a flowchart of an example method 400 of imaging optically interactive materials according to at least one embodiment of the present disclosure. The method 400 may be performed by any suitable system, apparatus, or device. For example, the microscopy system 100 or one or more components thereof may perform one or more operations associated with the method 400. Although illustrated with discrete blocks, the steps and operations associated with one or more of the blocks of the method 400 may be divided into additional blocks, combined into fewer blocks, or eliminated, depending on the particular implementation.

The method 400 may begin at block 410, where a radiation source emits broad bandwidth radiation with high spatial coherence. In some embodiments, the broad bandwidth radiation may include a beam of radiation. Additionally or alternatively, the broad bandwidth radiation may include one or more excitation pulses of the broad bandwidth radiation.

At block 420, a radiation modulator and/or a modulation mask may apply a time-varying modulation to the broad bandwidth radiation. In some embodiments, the broad bandwidth radiation may be an excitation pulse, and applying the time-varying modulation to the excitation pulse includes shaping the excitation pulse using a spinning spectral amplitude modulator disk as described in relation to FIGS. 1 and 2.

At block 430, a computing system associated with operations of a laser scanning microscope may identify optical interactions caused by the time-varying modulation of the broad bandwidth radiation. In some embodiments, the optical interactions may include nonlinear optical interactions as described in relation to FIGS. 1, 2, and 3.

At block 440, the computing system associated with operations of the laser scanning microscope may identify signals that are included in the optical interactions.

At block 450, the computing system associated with operations of the laser scanning microscope may extract respective spectral signatures associated with each respective signal. The spectral signatures associated with each respective signal may be the same as or similar to the fundamental pulse spectral output 300 described in relation to FIG. 3.

At block 460, the computing system associated with operations of the laser scanning microscope may determine a characteristic of an optically interactive material corresponding to each of the spectral signatures. In some embodiments, the optically interactive material may include biological compounds. For example, the optically interactive material may include biological molecules such as NADH, FAD, hemoglobin, cytochrome c, collagen, elastin, or any lipids. Additionally or alternatively, the biological compounds may include fluorescent molecules or other molecules or materials capable of inducing other optical signals, and the spectral signatures extracted from the signals of the optical interactions may include emission spectra associated with the fluorescent molecules or other induced optical signals associated with the molecules or other materials.

At block 470, the computing system associated with operations of the laser scanning microscope may identify the optically interactive materials by classifying the characteristics determined at block 460. For example, a particular optically interactive material may include a biological molecule and classifying the characteristics of the biological molecule may include performing tissue classification, a two-photon absorption spectra analysis of a third harmonic generator signal, a spectral determination, cargo content identification in vesicles, spatial structures identification in phase matching signatures, and/or coherent Raman scattering spectral imaging for histopathology based on the biological molecule.

Modifications, additions, or omissions may be made to the method 400 without departing from the scope of the disclosure. For example, the designations of different elements in the manner described is meant to help explain concepts described herein and is not limiting. Further, the method 400 may include any number of other elements or may be implemented within other systems or contexts than those described.

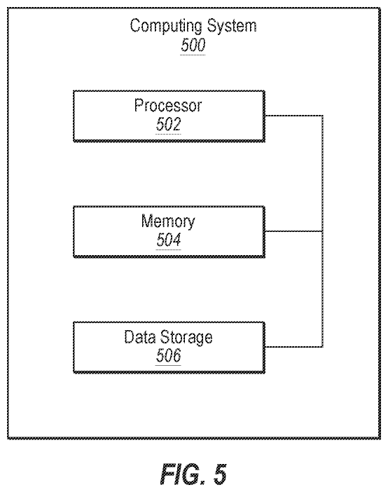

FIG. 5 illustrates a block diagram of an example computing system 500 that may be used to perform or direct performance of one or more operations described according to at least one implementation of the present disclosure. The computing system 500 may include, be included in, or correspond to the computing system 150 of FIG. 1. The computing system 500 may include a processor 502, a memory 504, and a data storage 506. The processor 502, the memory 504, and the data storage 506 may be communicatively coupled.

In general, the processor 502 may include any suitable special-purpose or general-purpose computer, computing entity, or processing device including various computer hardware or software modules and may be configured to execute instructions stored on any applicable computer-readable storage media. For example, the processor 502 may include a microprocessor, a microcontroller, a digital signal processor (DSP), an application-specific integrated circuit (ASIC), a Field-Programmable Gate Array (FPGA), or any other digital or analog circuitry configured to interpret and/or to execute computer-executable instructions and/or to process data. Although illustrated as a single processor, the processor 502 may include any number of processors configured to, individually or collectively, perform or direct performance of any number of operations described in the present disclosure.

In some implementations, the processor 502 may be configured to interpret and/or execute computer-executable instructions and/or process data stored in the memory 504, the data storage 506, or the memory 504 and the data storage 506. In some implementations, the processor 502 may fetch computer-executable instructions from the data storage 506 and load the computer-executable instructions in the memory 504. After the computer-executable instructions are loaded into memory 504, the processor 502 may execute the computer-executable instructions.

The memory 504 and the data storage 506 may include computer-readable storage media for carrying or having computer-executable instructions or data structures stored thereon. Such computer-readable storage media may include any available media that may be accessed by a general-purpose or special-purpose computer, such as the processor 502. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 502 to perform or control performance of a certain operation or group of operations.

Some portions of the detailed description refer to different modules or components configured to perform operations. One or more of the modules or components may include code and routines configured to enable a computing system to perform or control performance of one or more of the operations described therewith. Additionally or alternatively, one or more of the modules or components may be implemented using hardware including any number of processors, microprocessors (e.g., to perform or control performance of one or more operations), DSPs, FPGAs, ASICs or any suitable combination of two or more thereof. Alternatively or additionally, one or more of the modules or components may be implemented using a combination of hardware and software. In the present disclosure, operations described as being performed by a particular module or component may include operations that the particular module or component may direct a corresponding system (e.g., a corresponding computing system) to perform. Further, the delineating between the different modules or components is to facilitate explanation of concepts described in the present disclosure and is not limiting. Further, one or more of the modules or components may be configured to perform more, fewer, and/or different operations than those described such that the modules or components may be combined or delineated differently than as described.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of configured operations leading to a desired end state or result. In example implementations, the operations carried out require physical manipulations of tangible quantities for achieving a tangible result.

Unless specifically stated otherwise, as apparent from the discussion, it is appreciated that throughout the description, discussions utilizing terms such as detecting, determining, analyzing, identifying, scanning or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. Computer-executable instructions may include, for example, instructions and data which cause a general-purpose computer, special-purpose computer, or special-purpose processing device (e.g., one or more processors) to perform or control performance of a certain function or group of functions.

Unless specific arrangements described herein are mutually exclusive with one another, the various implementations described herein can be combined in whole or in part to enhance system functionality and/or to produce complementary functions. Likewise, aspects of the implementations may be implemented in standalone arrangements. Thus, the above description has been given by way of example only and modification in detail may be made within the scope of the present invention.

Terms used in the present disclosure and especially in the appended claims (e.g., bodies of the appended claims) are generally intended as “open terms” (e.g., the term “including” should be interpreted as “including, but not limited to.”).

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
emitting broad bandwidth radiation with high spatial coherence;
applying a time-varying modulation to the broad bandwidth radiation;
identifying a plurality of optical interactions caused by the time-varying modulation of the broad bandwidth radiation;
identifying one or more signals included in the plurality of optical interactions;
extracting one or more respective spectral signatures associated with each respective signal of the one or more signals;
determining a respective characteristic of an optically interacting material that corresponds to a respective spectral signature of the extracted spectral signatures; and
identifying one or more optically interacting materials by classifying one or more of the characteristics.

2. The method of claim 1, wherein the broad bandwidth radiation includes an excitation pulse.

3. The method of claim 1, wherein one or more optical interactions of the plurality of optical interactions are nonlinear optical interactions.

4. The method of claim 1, wherein the optically interacting material includes one or more molecules of a non-biological system.

5. The method of claim 1, wherein the optically interacting material includes one or more biological molecules.

6. The method of claim 5, wherein:
the broad bandwidth radiation is an excitation pulse; and
applying the time-varying modulation to the excitation pulse includes shaping the excitation pulse using a spinning spectral amplitude modulator disk, the spectral amplitude modulator disk including a plurality of modulation patterns.

7. The method of claim 6, wherein the spectral signatures extracted from the signals of the plurality of optical interactions include at least one of: fluorescent emission spectra, absorption spectra, linear scattering signals, or nonlinear scattering signals.

8. The method of claim 5, wherein classifying the characteristics of the biological molecule includes at least one of: tissue classification, two-photon absorption spectra analysis of a third harmonic generator signal, spectral determination of the biological molecule, cargo content identification in vesicles, spatial structures identification in phase matching signatures, or coherent Raman scattering spectral imaging for histopathology.

9. One or more non-transitory computer-readable storage media storing computer-readable instructions that, in response to execution by a processor, cause the processor to perform or control performance of operations comprising:
emitting broad bandwidth radiation with high spatial coherence;
applying a time-varying modulation to the broad bandwidth radiation;
identifying a plurality of optical interactions caused by the time-varying modulation of the broad bandwidth radiation;
identifying one or more signals included in the plurality of optical interactions;
extracting one or more respective spectral signatures associated with each respective signal of the one or more signals;
determining a respective characteristic of an optically interacting material that corresponds to a respective spectral signature of the extracted spectral signatures; and
identifying one or more optically interacting materials by classifying one or more of the characteristics.

10. The one or more non-transitory computer-readable storage media of claim 9, wherein the optically interacting material includes one or more biological molecules.

11. The one or more non-transitory computer-readable storage media of claim 10, wherein:
the broad bandwidth radiation is an excitation pulse; and
applying the time-varying modulation to the excitation pulse includes shaping the excitation pulse using a spinning spectral amplitude modulator disk, the spectral amplitude modulator disk including a plurality of modulation patterns.

12. The one or more non-transitory computer-readable storage media of claim 11, wherein the spectral signatures extracted from the signals of the plurality of optical interactions include at least one of: fluorescent emission spectra, absorption spectra, linear scattering signals, or nonlinear scattering signals.

13. A microscopy system, comprising:
a radiation source that is configured to emit broad bandwidth radiation with high spatial coherence;
a light labeling module positioned to receive the broad bandwidth radiation and configured to apply a time-varying modulation to the broad bandwidth radiation, the light labeling module comprising:
a first dispersive optical component configured to angularly disperse the broad bandwidth radiation incident on the first dispersive optical component;
a first lens configured to focus the dispersed broad bandwidth radiation to a line on a radiation modulator;
the radiation modulator that includes a modulation mask, wherein the modulation mask includes a first modulation pattern that shapes the broad bandwidth radiation from the first lens into modulated spectral components; and
a second lens and a second dispersive optical component configured to combine the modulated spectral components into modulated radiation;
a laser scanning microscope positioned to receive the modulated radiation and configured to scan a sample that includes one or more optically interacting materials with the modulated radiation;
one or more optical receivers positioned to receive output from the laser scanning microscope;
a processor coupled to the one or more optical receivers; and
one or more non-transitory computer-readable storage media coupled to the processor and storing computer-readable instructions that, in response to execution by the processor, cause the processor to perform or control performance of operations comprising:
identifying in the output of the laser scanning microscope a plurality of optical interactions caused by the time-varying modulation of the broad bandwidth radiation;
identifying one or more signals included in the plurality of optical interactions;
extracting one or more respective spectral signatures associated with each respective signal of the one or more signals;
determining a respective characteristic of an optically interacting material that corresponds to a respective spectral signature of the extracted spectral signatures; and
identifying the one or more optically interacting materials by classifying one or more of the characteristics.

14. The system of claim 13, wherein the optically interacting material includes one or more molecules of a non-biological system.

15. The system of claim 13, wherein the optically interacting material includes one or more biological molecules.

16. The system of claim 15, wherein:
the broad bandwidth radiation is an excitation pulse; and
applying the time-varying modulation to the excitation pulse includes shaping the excitation pulse using a spinning spectral amplitude modulator disk, the spectral amplitude modulator disk including a plurality of modulation patterns.

17. The system of claim 16, wherein the spectral signatures extracted from the signals of the plurality of optical interactions include at least one of: fluorescent emission spectra, absorption spectra, linear scattering signals, or nonlinear scattering signals.

18. The system of claim 15, wherein classifying the characteristics of the biological molecule includes at least one of: tissue classification, two-photon absorption spectra analysis of a third harmonic generator signal, spectral determination of the biological molecule, cargo content identification in vesicles, spatial structures identification in phase matching signatures, or coherent Raman scattering spectral imaging for histopathology.

19. The system of claim 13, wherein the modulation mask is spun at an angular velocity to generate a spinning modulation mask that includes a second modulation pattern based on the first modulation pattern and the angular velocity of the modulation mask.

20. The system of claim 13, wherein:
the modulation mask further includes a second modulation pattern, the first modulation pattern and the second modulation pattern each being angularly multiplexed on the modulation mask; and
the modulation pattern is located on the modulation mask at a first index, and the second modulation pattern is located on the modulation mask at a second index, the first index and the second index being angularly offset from each other.
